(19) United States
(12) Patent Application Publication
(10) Pub. No.: US 2004/0119185 A1
(43) Pub. Date: Jun. 24, 2004

(54) Method for manufacturing opened-cell plastic foams

(76) Inventor: Ching Hsi Chen, Taichung (TW)

Correspondence Address: TROXELL LAW OFFICE PLLC, SUITE 1404, 5205 LEESBURG PIKE, FALLS CHURCH, VA, 22041, US

(21) Appl. No.: 10/326,135

(22) Filed: Dec. 23, 2002

(51) Int. Cl. B29C 44/02

(52) U.S. Cl. 264/51; 264/53

(57) ABSTRACT

A method for manufacturing opened-cell plastic foams includes a plurality of steps including a step of mixing ethylene vinyl acetate copolymer (EVA) or polyethylene resins (PE), a preset percentage of a blowing agent and a vulcanizing agent, pigment, aids agent, and hollow porcelain balls or hollow micro grains evenly, a step of placing the mixed material in a mold to proceed batch-foaming once or twice. And a step of opening the mold for instant foaming process can let a solid shell of the mixed material with porous chamber structure produce ruptured holes so that the finished product of plastic foams may have good airiness and soft flexibility.

### BACKGROUND OF THE INVENTION

This invention relates to a method for manufacturing opened-cell plastic foams, particularly to one mixing hollow porcelain balls or hollow micro grains not combinable with or not reactive to plastic in plastic to produce numerous ruptured holes with a porous chamber structure in a solid shell of a foam so as to manufacture airy opened-cell plastic foams.

Plastic foams have excellent property of buffer, soundproofing, heat insulation, floating and easy processing so that they are widely used for making shoe soles, shoe insoles, stuffing, cushions and packing material. They are classified into closed-cell plastic foams and opened-cell plastic foams according to the structure of a foam chamber, and the former has air cells independent from one another and not communicating with one another, but has bad airiness, generally used for water floats. On the contrary, the latter has good airiness and liquid absorbing function, with air cells communicating with one another and an outer shell having many holes, so they have comparatively good compressibility and airiness.

As for shoe material, plastic foams are largely used for shoe insoles, as the airiness and agility they have good effect to humane health and comfortableness, but most shoe-insole makers still make use of closed-cell plastic foams not airy and easily producing odors. Opened-cell plastic foams are manufactured with common projecting machines as a thin sheet continuously projected out of the machine, and the foam sheet has a little thickness, including a process of foaming with radiant rays and a process of foaming with butane involving high expenditure for equipment and danger of gas explosion, making up disadvantageous elements to the cost and security. Moreover, its physical property and specification cannot meet special demands by various applications and processes in the later stage.

### SUMMARY OF THE INVENTION

The purpose of the invention is to offer a method for manufacturing open-cell plastic foams, which includes a plurality of steps of mixing hollow porcelain balls or hollow micro grains not combinable with or not reactive to plastic in plastic for mixing them together evenly, and this mixed material is put in preset molds for proceeding batch foaming once or twice so that the mixed plastic material may produce ruptured holes in a solid shell of porous chambers in the instant foaming at the moment of opening the mold, so as to get opened-cell plastic foams of large thickness, good airiness and high flexibility.

### BRIEF DESCRIPTION OF A DRAWING

This invention will be better understood by referring to the accompanying drawing, wherein:

FIG. 1 is a cross-sectional view of an opened-cell plastic foam made by a method for manufacturing opened-cell plastic foams in the present invention.

### DETAILED DESCRIPTION OF THE PREFERRED EMBODIMENT

A preferred embodiment of the present invention includes a plurality of steps described as follows.

1. A first step of mixing proper quantity of ethylene vinyl acetate copolymer (EVA for short) or polyethylene resins (PE for short), a blowing agent of a preset percentage, a vulcanizing agent of a preset percentage, a pigment, aids agent, and proper quantity of hollow porcelain balls or hollow micro grains not combinable with or not reactive to plastic, and mixing them to make the porcelain balls or the micro grains evenly pervade in the plastic. In this embodiment, hollow porcelain balls of 12-350 μm are used, having ingredients of silicon oxide or aluminum oxide, and the hollow micro grains may be hollow glass or the like. And it is preferable that the hollow porcelain balls or the hollow micro grains are balls having air bubbles sealed inside, having a lightweight. And balls of regular or irregular shape may be usable.

2. A second step is to place the mixed material finished the first step in a first mold for proceeding pressure adding and heating at the temperature 120-180° C. for 25-30 minutes so as to let the blowing agent dissolve to produce gas, which may be pervade in the material placed in the sealed mold by the preset pressure added.

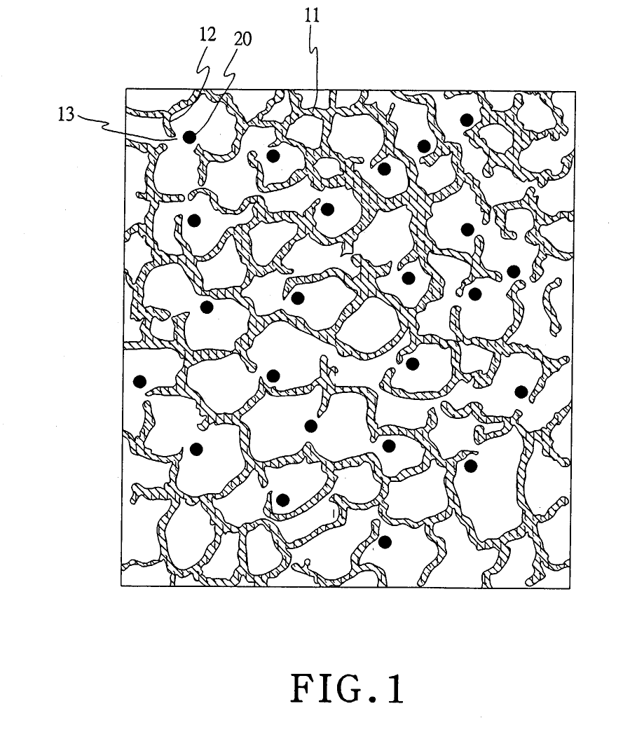

3. A third step is to take out the first foamed material 10 finished the second step out of the first mold so that the gas stored in the material in the mold may instantly inflate because of the pressure in the mold released at the moment of opening the mold, and resulting in an air chamber structure of airy cells 11 shown in FIG. 1. The hollow porcelain balls 20 evenly pervaded in the plastic material may make up an obstacle to instant inflation caused by a solid shell 12 of the foamed material owing to the property of not combinable with or not reactive to the plastic, so that the solid shell may produce ruptured holes 13 to form an opened-cell plastic foam. Then the plastic foam inflates to the dimension of 6-8 times of the first foamed plastic.

4. A fourth step is to place the first foamed plastic finished the third step into a second mold for proceeding once again pressure adding and heating at temperature 165-180° C. for 15-25 minutes to let the blowing agent continue resolving to produce more gas to be accumulated in the plastic material in the second mold.

5. A fifth step is to take out the second foamed finished product from the second mold finishing the fourth step. The finished second plastic foam or product has a dimension of 3-5 times the first foamed material finished the third step.

Next, the method for manufacturing opened-cell plastic foams has the following effects.

The plastic and the other ingredients mixed and stirred together is placed in a mold for one time or two time processing of pressure adding and heating of batch foaming for opened-cell foams so that the foaming effectiveness may be elevated to inflate the mixed material many times larger and finished products may have a thickness so large as 8-10 cm and soft flexibility may be obtained. But the aforesaid conventional method for manufacturing of using projecting machines and radiation of radiant rays or producing air bubbles in plastic by means of mixing gas therein can only produce products of a thickness small as 1 cm or so, then its applicable scope is very narrow. In addition, the method of the invention can adjust the percentage of the hollow porcelain balls to produce products of various airiness with thickness large as 8-10 cm. to meet various requirements of products

Moreover, the invention includes the hollow porcelain balls or the hollow micro grains not combinable with or not reactive to plastic are mixed and stirred with plastic evenly. In the opening the mold and instant foaming process, a porous chamber structure is produced in the mixed material, forcing a solid shell of the mixed material produce ruptured holes to make up an opened-cell plastic foam. Besides, the quantity of the hollow porcelain balls or the hollow micro grains can be adjusted variously between 15% and 50% of the plastic used. The more the hollow porcelain balls or the hollow micro grains, the more the opened-cells or the holes, the less the closed portion of the solid shell, and the better the airiness and the flexibility.

While the preferred embodiment of the invention has been described above, it will be recognized and understood that various modifications may be made therein and the appended claims are intended to cover all such modifications that may fall within the spirit and scope of the invention.

I claim:

1. A method for manufacturing opened-cell plastic foams, said method comprising:
A first step of mixing a proper quantity of ethylene vinyl acetate copolymer (EVE) or polyethylene resins (PE), a preset proportion of a blowing agent, a vulcanizing agent, aids agent and a proper amount of hollow porcelain balls or hollow micro grains not combinable with or not reactive to said plastic (EVA or PE) to let said hollow porcelain balls or said hollow micro grains pervade evenly in said plastic:
A second step of placing said mixed material finishing said first step in a first mold for proceeding pressure adding and heating to let said blowing agent dissolve to produce gas: and,
A third step of opening the first mold for taking out the first foamed material finishing the second step to let the gas produced and stored in the first mold to instant inflate at the moment when the first mold is opened to release the inside pressure, said mixed material producing an airy chamber structure wherein air the hollow porcelain balls or the hollow micro grains evenly pervading in said plastic forces a solid shell of said first foamed material produce ruptured holes in the process of instant inflation at the moment when said first mold is opened, owing to the property of the hollow porcelain balls or the hollow micro grains not combining with or not reactive to plastic, said first foamed material finally becoming a half-finished opened-cell plastic foam.

2. The method for manufacturing opened-cell plastic foams as claimed in claim 1, wherein said first foamed material is further placed in a second mold for proceeding once again pressure adding and heating, said first foamed material becoming a finished product having a dimension of several times the first foamed material after finishing the second heating for foaming in the second mold and taken out of the second mold.

3. The method for manufacturing opened-cell plastic foams as claimed in claim 1, wherein said hollow porcelain balls or said hollow micro grains in said finished product contain air cells regularly or irregularly located.

4. The method for manufacturing opened-cell plastic foams as claimed in claim 1, wherein said hollow porcelain balls in the finished foams have a size of 12-350 μm, consisting of silicon oxide and aluminum oxide.

5. The method for manufacturing opened-cell plastic foams as claimed in claim 1, wherein the temperature used for heating said first mold is in the scope of 120-180° C. and the needed heating time is in the scope of 25-30 minutes.

6. The method for manufacturing opened-cell plastic foams as claimed in claim 2, where in the temperature for heating said second mold is in the scope of 165-180° C., and the needed heating time is in the scope of 15-25 minutes.
